(19) United States
(12) Patent Application Publication
(10) Pub. No.: US 2010/0174806 A1
(43) Pub. Date: Jul. 8, 2010

(54) Data Processing Method, Apparatus And System

(75) Inventor: Youwei Hua, Shenzhen City (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen City (CN)

(21) Appl. No.: 12/725,521

(22) Filed: Mar. 17, 2010

Related U.S. Application Data
(63) Continuation of application No. PCT/CN2008/072182, filed on Aug. 28, 2008.

(30) Foreign Application Priority Data
Sep. 27, 2007 (CN) 200710151711.9

(51) Int. Cl. G06F 15/16

(52) U.S. Cl. 709/219; 709/236

(57) ABSTRACT

The present invention relates to network techniques. A data processing method, apparatus and system is disclosed. The data processing method includes: a data distribution source transmitting data to a transfer server; the transfer server transmitting the data to a first client connected with the transfer server; and the first client transmitting the data to a second client connected with the first client. A data processing apparatus and a data processing system are also provided accordingly.

### CROSS-REFERENCE TO RELATED APPLICATIONS

This application is a continuation of International application No. PCT/CN2008/072182, filed Aug. 28, 2008. This application claims the benefit and priority of Chinese Patent Application No. 200710151711.9, filed Sep. 27, 2007. The entire disclosures of each of the above applications are incorporated herein by reference.

### FIELD

The present disclosure relates to data transmission techniques, and more particularly, to a data processing method, apparatus and system.

### BACKGROUND

This section provides background information related to the present disclosure which is not necessarily prior art.

With the development of wide-band techniques, Internet users have wider and wider bandwidth to access the Internet. Therefore, besides traditional text and image information, the Internet users can receive audio and/or video information which requires higher bandwidth from the Internet. Thus, the Internet users can acquire more information from the Internet. Since the audio/video information can exhibit information more intuitively, its application becomes more and more popular on the Internet.

Existing audio/video sharing systems on the Internet generally adopt a Client/Server (C/S) mode, i.e., all clients are directly connected with a server and directly receive data from the server. A network node of shared data directly transmits the data to the server. The server broadcasts the data to all the clients connected with the server. As such, the clients may obtain the corresponding data. The network node of the shared data may be any node in the network, and may also be the server.

Since there is a large amount of information on the Internet, when the C/S manner is adopted in the audio/video sharing system, the server has to directly broadcast the data to all the clients if there are a large number of clients, and thus, most of the bandwidth of the server may be occupied, which dramatically increases the processing load of the server and has a high requirement for the server. As such, the acquisition cost and the maintenance cost of the server is high.

### SUMMARY

This section provides a general summary of the disclosure, and is not a comprehensive disclosure of its full scope or all of its features.

An object of embodiments of the present invention are to provide a data processing method, apparatus and system, so as to solve the problem that the bandwidth of a server is excessively occupied and the load of the server is greatly increased.

The object of the embodiments of the present invention is realized by the following technical solution:

receiving data from a data distribution source;

transmitting the data to a first client; and,

transmitting the data to a second client through the first client.

Or, the object is realized by the following technical solution:

receiving data transmitted by a data distribution source through a transfer server; and,

transmitting the data to a second client.

The embodiments of the present invention also provide a data processing apparatus, including:

a data identifier receiving unit, adapted receive a data identifier;

a determining unit, adapted to determine whether data corresponding to the data identifier is stored;

a request message transmitting unit, adapted to transmit to a network entity transmitting the data identifier a request message to request the data corresponding to the data identifier when the data corresponding to the data identifier are not stored;

a data receiving unit, adapted to receive the data corresponding to the data identifier from the network entity; and,

a data storing unit, adapted to store the data.

The embodiments of the present invention further provide a data processing system, including:

a data distribution source and a transfer server, wherein:

the data distribution source is adapted to configure, after obtaining data, a data identifier for the data, transmit the data identifier, receive a first request message from the transfer server and transmit the data to the transfer server, the first request message being for requesting the data corresponding to the data identifier; and,

the transfer server is adapted to receive the data identifier, transmit the first request message to the data distribution source to request the data corresponding to the data identifier when the data corresponding to the data identifier are not stored, and receive and store the data.

It can be seen from the above technical solution provided by the embodiments of the present invention that, a data identifier is introduced in the embodiments of the present invention, during data transmission, the data identifier is transmitted firstly, and only after receiving a request message requesting the data corresponding to the data identifier, the corresponding data will be transmitted. Thus, the server does not need to directly broadcast the data to the clients. In addition, in the embodiments of the present invention, the connection between the clients is established in a P2P manner. As such, the server only needs to transmit the data to a part of clients to realize transmission of the data in the whole network, which decreases the load of the server and will not occupy much bandwidth of the server. Therefore, an ordinary server is competent, which reduces the acquisition cost and the maintenance cost of the server.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating a network structure according to an embodiment of the present invention.

FIG. 2 is a flowchart illustrating a data transmitting method according to an embodiment of the present invention.

FIG. 3 is a flowchart illustrating a data processing method according to an embodiment of the present invention.

FIG. 4 is a block diagram illustrating a data processing apparatus according to a first embodiment of the present invention.

FIG. 5 is a block diagram illustrating a data processing apparatus according to a second embodiment of the present invention.

FIG. 6 is a schematic diagram illustrating a data processing system according to an embodiment of the present invention.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The present invention will be described hereinafter in detail with reference to embodiments and accompanying drawings to make the object, the technical solution and merits therein clearer.

In order to avoid the client from directly establishing a connection with the server in the C/S manner, an embodiment of the present invention provides a new network structure, as shown in FIG. 1. The server respectively establishes a connection with n clients (client 1, . . . , client n) in the existing C/S manner, i.e., the server can establish connections with n clients simultaneously, wherein n may be determined according to processing capabilities and bandwidth of the server. The clients directly connected with the server are referred to as first clients. The above n clients respectively establish connections with other clients (client n+1, . . . , client n+m, client n+m+1, . . . , client n+m+p) in a Peer To Peer (P2P) manner. The clients which are connected with the first clients instead of being directly connected with the server are referred to as second clients, third clients, fourth clients, and etc. FIG. 1 only depicts a part of connections between the clients. In practical applications, there may be much more connections between the clients, even there may be a connection between any two clients.

In practical applications, the server is not fixedly connected with some clients in the C/S manner. When desiring to access, a client may obtain information of the clients to which it can connect from the server or other network nodes, so as to establish a P2P connection with one of the clients preferably. Only when there is no available client to connect, it will establish a connection with the server in the C/S manner. Therefore, in practical applications, although the server can establish connections with n clients, it generally establishes connections only with less than n clients. As such, in case that a client cannot establish a connection with other clients, it is ensured that the client can establish a connection with the server.

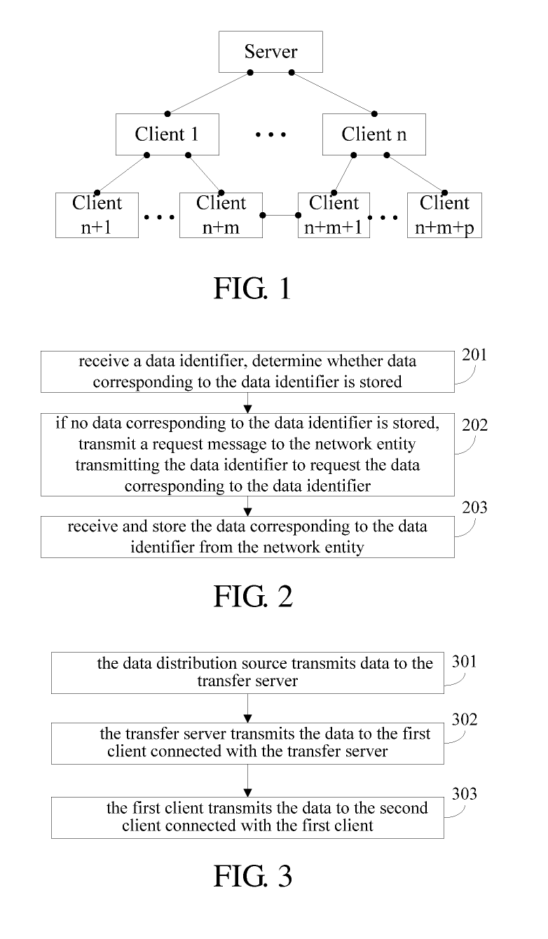

In this network structure, the server cannot transmit data to all the clients by broadcast. Therefore, an embodiment of the present invention provides a data transmitting method. As shown in FIG. 2, the method includes the following steps:

Step 201: receive a data identifier and determine whether data corresponding to the data identifier is stored.

The data identifier is corresponding to the data. Each data identifier corresponds to a single piece of data. In practical applications, if the data have a big size, it is possible to divide the data into data blocks which are then transmitted respectively. At this time, each data block is allocated with a data block identifier. The size of the data block may be configured by a system according to practical requirements. For example, the system may configure a standard data size in advance. If the data have a size larger than the standard size, the data should be divided into data blocks, where, the data identifier occupies little bandwidth than the data. Therefore, if a network node has already had the data or the data blocks, there is no need to transmit the data or the data blocks to the network node again, so as to save bandwidth resources.

After receiving the data identifier, it is determined whether the data corresponding to the data identifier is stored. If the corresponding data is stored, it is not needed to respond to the data identifier received. The determination of whether the data corresponding to the data identifier are stored may be made by directly determining whether there are data that can generate the corresponding data identifier among the stored data. The above is applicable for the situation that each node in the network adopts a same manner for generating the data identifier. If the data as well as the corresponding data identifier are stored, it is also possible to determine whether the corresponding data identifier is stored to determine whether the data are stored.

Step 202: if no data corresponding to the data identifier are stored, transmit a request message to the network entity transmitting the data identifier to request the data corresponding to the data identifier.

If no data corresponding to the data identifier are stored, it is required to obtain the data. In particular, it is possible to transmit the request message to the network entity transmitting the data identifier, wherein the request message carries at least the data identifier. The detailed implementation of the request message may be different with respect to different network protocols. The request message is used in the present invention for facilitating the description but not to restrict the name of the message.

Step 203: receive and store the data corresponding to the data identifier from the network entity.

After receiving the request message, the network entity transmitting the data identifier transmits the data corresponding to the data identifier. Accordingly, it is needed to receive and store the data from the network entity which corresponds to the data identifier.

It is known from the above that, a data identifier is introduced in the embodiments of the present invention. Therefore, during data transmission, the data identifier will be transmitted firstly. Only after receiving the request message requesting the data corresponding to the data identifier, the corresponding data will be transmitted. As such, the server does not need to directly broadcast the data to the clients any more.

Based on the data transmitting method provided by the embodiment of the present invention, a data processing method is provided by an embodiment of the present invention. As shown in FIG. 3, the data processing method includes the following steps:

Step 301: a data distribution source transmits data to a transfer server.

Wherein, the data distribution source may adopts the processing procedure provided by the data processing method provided by the embodiment of the present invention, and after obtaining the data, the data distribution source may adopt the following procedure to transmit the data to the transfer server:

The data distribution source transmits a data identifier corresponding to the data to the transfer server;

The data distribution source receives a request message from the transfer server, the request message requesting the data corresponding to the data identifier; and,

The data distribution source transmits the data to the transfer server.

Step 302: the transfer server transmits the data to a first client connected with the transfer server.

The first client may be connected with the transfer server in a C/S manner, where, after obtaining the data, the transfer server may transmit the data to the first client by the following steps:

The transfer server transmits the data identifier to the first client;

The transfer server receives a request message from the first client, the request message requesting the data corresponding to the data identifier; and,

The transfer server transmits the data to the first client.

Step 303: the first client transmits the data to a second client connected with the first client.

The second client may be connected with the first client in a P2P manner. In practical applications, the first client may further transmit the data to a third client, a fourth client, and etc. The first client may transmit the data to any client connected with the first client. Wherein, the first client may transmit the data to the second client by the following steps:

The first client transmits the data identifier to the second client;

The first client receives a request message from the second client, the request message requesting the data corresponding to the data identifier; and,

The first client transmits the data to the second client.

It is known from the above that, a data identifier is introduced in this embodiment. During data transmission, the data identifier is transmitted firstly. And only after receiving a request message requesting the data corresponding to the data identifier, the corresponding data will be transmitted. Thus, the server does not need to directly broadcast the data to the clients. In addition, in the embodiment of the present invention, the connection between the clients is established in a P2P manner. As such, the server only needs to transmit the data to some of the clients to realize transmission of the data in the whole network, which decreases the load of the server and will not occupy much bandwidth of the server. Therefore, an ordinary server is competent, which reduces the acquisition cost and the maintenance cost of the server. When applying the embodiment in the network structure as shown in FIG. 1, only a few clients establish connections with the server in the C/S manner. And the clients establish connections with each other by the P2P manner. As such, even if there are a larger number of clients, the bandwidth of the server will not be excessively occupied and no overmuch load will be laid on the server. Therefore, no high-performance server is necessitated and the acquisition and maintenance cost is reduced accordingly.

Generally, each network entity in the system obtains the data according to the data identifier in a same way. Therefore, after the data are stored, the corresponding data identifier may be not stored. But in practical applications, in order to increase the determining speed or in case that various network entities obtain the data according to the data identifier in a different manner, the data identifier should also be stored after the data are stored, and thus, after receiving a data identifier, it is possible to determine whether the data corresponding to the data identifier are stored by determining whether the same data identifier is stored. Thus, the determining speed is increased.

The network entity may also have a connection with another network entity. For example, the server establishes a connection with a client in the C/S manner, the client establishes a connection with another client in the P2P manner, and so on. Therefore, after receiving the data, it is required to further transmit the data identifier. In particular, with respect to different connection establishing manners, different entities will be the object of the transmission. For example, it is the client connected with the server in the C/S manner that the server transmits the data identifier to, and it is another client connected with the client in the P2P manner that the client transmits the data identifier to.

After transmitting the data identifier, a request message requesting the data corresponding to the data identifier may be received. If the request message is received, the corresponding data is transmitted to the network entity transmitting the request message, so as to implement data transmission in the network.

An example will be given hereinafter to describe the data processing method provided by the embodiment of the present invention. In particular, the example describes the data transmission under the network structure as shown in FIG. 1.

After receiving a data identifier from a data source, a server obtains the corresponding data from the data source if the corresponding data are not stored. In practical applications, the server itself may also be a data source. At this time, if the server has new data, a corresponding data identifier will be generated.

The server transmits the data identifier to clients (client 1, . . . , client n) which are connected with the server in the C/S manner. After receiving the data identifier, the clients obtain the corresponding data from the server if the corresponding data are not stored.

A client transmits the data identifier to other clients which are connected with the client in the P2P manner. If a client has no the corresponding data, the client obtains the corresponding data from the client transmitting the data identifier. The process will be repeated until the data are transmitted to the whole system. The connections between the clients are established in the P2P manner. Therefore, it is possible that a certain client receives the data identifier transmitted from another client although it has had the corresponding data. In this case, since what is transmitted is the data identifier but not the data, the network bandwidth will not be excessively occupied.

In practical applications, the client connects into or disconnect from the network at any time. Therefore, in order to ensure the reliability of the network, the client generally connects into the network as follows: firstly determine whether another client is available to be connected with, if available, connect to the client so as to connect into the network; if not available, determine whether it is possible to connect to the transfer server, if it is possible, connect to the transfer server so as to connect into the network; if it is also not possible to connect to the transfer server, an attempt to connect to the data distribution source may be performed.

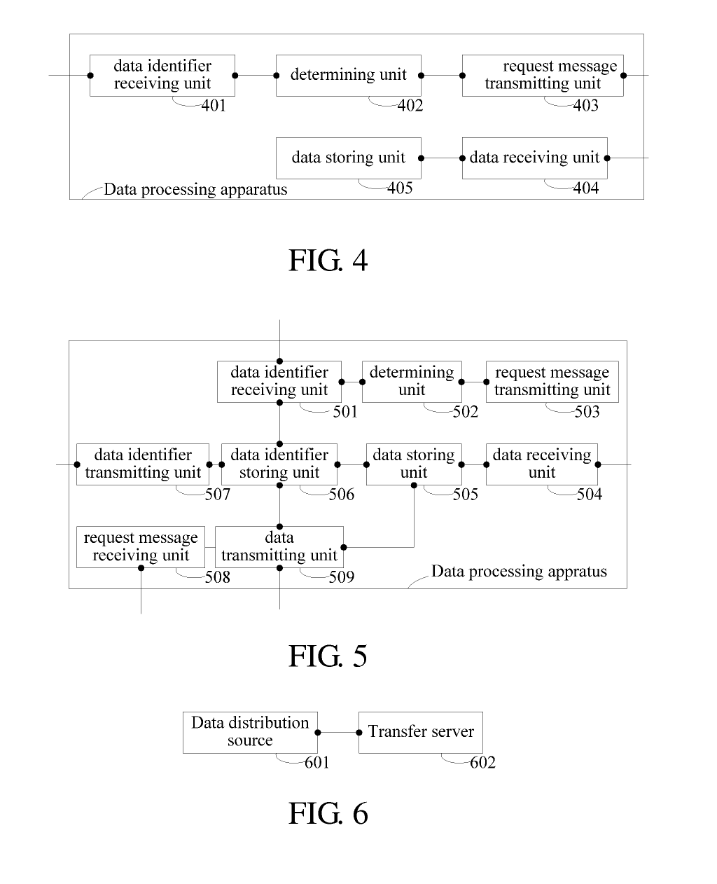

Corresponding to the data processing method, embodiments of the present invention also provide a data processing apparatus. As shown in FIG. 4, the data processing apparatus according to a first embodiment of the present invention includes:

A data identifier receiving unit 401, adapted to receive a data identifier;

A determining unit 402, adapted to determine whether data corresponding to the data identifier are stored;

In particular, the determining unit 402 may determine whether the stored data have the data identifier; if the corresponding data identifier has been stored after the data are stored, it is possible to determine whether the data identifier is stored to determine whether the corresponding data are stored.

A request message transmitting unit 403, adapted to transmit a request message to a network entity transmitting the data identifier to request the data corresponding to the data identifier when the determining unit 402 determines that no data corresponding to the data identifier are stored;

A data receiving unit 404, adapted to receive the data corresponding to the data identifier from the network entity transmitting the data identifier; and,

A data storing unit 405, adapted to store the data.

The data processing apparatus provided by the embodiment of the present invention may be taken as a server or a client in an audio/video information sharing system. It can be seen from the above that, when the data processing apparatus provided by the embodiment of the present invention is taken as the server or the client in the audio/video information sharing system, it is ensured that a client can accurately receive the corresponding data in case that the client does not have a connection with the server in the C/S manner and less bandwidth is occupied. When the network structure as shown in FIG. 1 is adopted, only a few clients establish connections with the server in the C/S manner. And the clients establish connections with each other by the P2P manner. As such, even if there are a larger number of clients, the bandwidth of the server will not be excessively occupied and no overmuch load will be laid on the server. Therefore, no high-performance server is necessitated and the acquisition and maintenance cost is reduced accordingly.

In practical applications, in order to increase the processing speed of the determining unit, the data processing apparatus provided by the embodiment of the present invention may further include:

A data identifier storing unit, adapted to store the data identifier after the data receiving unit receives the data.

After the data identifier is stored, if receiving a data identifier from another client or a server, the determining unit may directly determine whether a same data identifier is stored in order to determine whether the corresponding data are stored. As such, the determination speed of the determining unit and the processing efficiency of the data processing apparatus are increased.

The above data processing apparatus according to the first embodiment only depicts a data receiving function. In practical applications, the data processing apparatus may also have a data transmitting function besides the data receiving function. Therefore, a second embodiment of the present invention further provides a data processing apparatus. As shown in FIG. 5, the data processing apparatus includes:

A data identifier receiving unit 501, adapted to receive a data identifier;

A determining unit 502, adapted to determine whether data corresponding to the data identifier are stored;

In particular, the determining unit 502 may determine whether the stored data have the data identifier; if the corresponding data identifier has been stored after the data are stored, it is also possible to determine whether the data identifier is stored in order to determine whether the corresponding data are stored;

A request message transmitting unit 503, adapted to transmit a request message to an network entity transmitting the data identifier to request the data corresponding to the data identifier if the determining unit 502 determines that no data corresponding to the data identifier are stored;

A data receiving unit 504, adapted to receive the data corresponding to the data identifier from the network entity transmitting the data identifier;

A data storing unit 505, adapted to store the data;

A data identifier storing unit 506, adapted to store the data identifier after the data receiving unit 504 receives the data;

A data identifier transmitting unit 507, adapted to transmit the data identifier;

A request message receiving unit 508, adapted to receive a request message requesting the data corresponding to the data identifier; and,

A data transmitting unit 509, adapted to transmit the data after the request message receiving unit 508 receives the request message.

It can be seen from the above that, after receiving the data, the data processing apparatus provided by the second embodiment of the present invention transmits the data outward, so as to ensure the transmission of the data in the network.

Embodiments of the present invention further provide a data processing system. As shown in FIG. 6, the data processing system according to an embodiment of the present invention includes a data distribution source 601 and a transfer server 602; wherein:

The data distribution source 601 is adapted to generate, after obtaining data, a data identifier of the data and transmit the data identifier, receive a first request message from the transfer server 602 which requests the data corresponding to the data identifier and transmit the data to the transfer server 602.

Wherein the data identifier may be generated according to an existing abstract generating algorithm; alternatively, it is also possible to index each data block stored and take the index as the data identifier; in particular, the detailed process for generating the data identifier is not limited herein; any method which can establish a corresponding relationship between the data identifier and the data is within the protection scope of the present invention.

The transfer server 602 is adapted to receive the data identifier, transmit the first request message to the data distribution source 601 to request the data corresponding to the data identifier if no data corresponding to the data identifier are stored, receive and store the data from the data distribution source 601.

It can be seen from the above that, the first embodiment of the data processing system describes the data transmission between the data distribution source and the transfer server. In practical applications, the transfer server may also be used as a data distribution source. In this case, the above data transmission procedure will not happen.

In practical applications, the data processing system may further include a first client connected with the transfer server 602. The first client is connected with transfer server in a C/S manner. The number of the first client herein is at least one.

The transfer server 602 is further adapted to transmit the data identifier to the first client after storing the data.

The first client is adapted to receive the data identifier, transmit a second request message to the transfer server 602 to request the data corresponding to the data identifier if no data corresponding to the data identifier are stored.

The transfer server 602 is further adapted to transmit the data to the first client after receiving the second request message.

Now, the data obtained by the transfer server have been transmitted to the client connected with the transfer server in the C/S manner.

In practical applications, the data processing system may further include a second client connected with the first client in the P2P manner. The number of the second client is at least one.

The first client is further adapted to transmit the data identifier to the second client after storing the data, receive a third request message from the second client requesting the data corresponding to the data identifier, and transmit the data to the second client.

The second client is adapted to receive the data identifier, transmit the third request message to the first client to request the data corresponding to the data identifier if no data corresponding to the data identifier are stored, receive and store the data from the first client.

Now, the data of the first client have been transmitted to the second client connected with the first client in the P2P manner.

In practical applications, the data processing system may further include a third client. If the third client does not receive the data from the first client or the second client, the third client is adapted to transmit a fourth request message to the transfer server 602 to request the data corresponding to the data identifier, receive and store the data from the transfer server 602.

The transfer server 602 is further adapted to receive the fourth request message, and transmit the data requested by the fourth request message to the third client.

Furthermore, the data processing system may further include a fourth client. If the fourth client does not receive the data from the first client, or the second client or the transfer server, the third client is adapted to transmit a fifth request message to the data distribution source 601 to request the data corresponding to the data identifier, receive and store the data from the data distribution source 601.

The data distribution source 601 is further adapted to receive the fifth request message and transmit the data requested by the fifth request message to the fourth client.

Certainly, in practical applications, there may be a fifth client, even a sixth client, etc. The data transmission between them is similar to that between the first client and the second client and will not be repeated herein.

Those with ordinary skill in the art should know that, all or some steps in the method of the embodiments of the present invention may be implemented by instructing related hardware via a program. The program may be stored in a computer-readable storage medium. The storage medium may be ROM, disk or CD, etc.

The foregoing is only detail descriptions for the data processing method, apparatus and system provided by the embodiments of the present invention, and the foregoing descriptions of the embodiment are for helping understanding the method and idea of the present invention; and meanwhile, any changes to the specific implementation modes and application scopes can be made by those ordinarily skilled in the art according to the idea of the present invention. To sum up, the content of the specification should not be considered as limitation to the present invention.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A data processing method, characterized by, comprising:
receiving data from a data distribution source;
transmitting the data to a first client; and,
transmitting the data to a second client through the first client.

2. The method of claim 1, characterized by, said receiving the data from the data distribution source comprising:
receiving a data identifier corresponding to the data from the data distribution source; and,
obtaining the data according to the data identifier.

3. The method of claim 2, characterized by,
when said obtaining the data according to the data identifier fails, transmitting a request message to the data distribution source, the request message comprising the data identifier corresponding to the data; and,
receiving the data which is transmitted according to the data identifier by the data distribution source.

4. The method of claim 2, characterized by, when the size of the data exceeds a pre-defined size, said receiving the data identifier corresponding to the data from the data distribution source comprising:
receiving the data identifier corresponding to the data from the data distribution source, the data identifier comprising data block identifiers configured by the data distribution source for data blocks which the data are divided into by the data distribution source, and each data block is in a pre-defined size.

5. The method of claim 1, characterized by, after transmitting the data to the second client through the first client, when the second client does not receive the data, the method further comprising:
receiving a data transmitting request from the second client; and transmitting the data to the second client according to the data transmitting request; or,
transmitting, by the second client, a data transmitting request to the data distribution source; and receiving, by the second client, the data transmitted according to the data transmitting request by the data distribution source.

6. The method of claim 1, characterized by, the first client being connected with the second client in a point to point manner.

7. A data processing method, characterized by, comprising:
receiving data transmitted by a data distribution source through a transfer server; and,
transmitting the data to a second client.

8. The method of claim 7, characterized by, said receiving the data transmitted by the data distribution source through the transfer server comprising:
receiving, through the transfer server, a data identifier corresponding to the data transmitted by the data distribution source; and,
obtaining the data according to the data identifier.

9. The method of claim 8, characterized by, after obtaining the data according to the data identifier, when said obtaining fails, the method further comprising:
transmitting a transmitting request to the transfer server, the transmitting request comprising the data identifier corresponding to the data; and,
receiving the data transmitted according to the data identifier by the transfer server.

10. The method of claim 8, characterized by, said transmitting the data to the second client comprising:
transmitting the data identifier corresponding to the data to the second client;
when the second client fails to obtain the data according to the data identifier, the method further comprising:
receiving a request message from the second client, the request message comprising the data identifier corresponding to the data; and
transmitting the data to the second client according to the data identifier.

11. A data processing apparatus, characterized by, comprising:
a data identifier receiving unit, adapted receive a data identifier;
a determining unit, adapted to determine whether data corresponding to the data identifier is stored;
a request message transmitting unit, adapted to transmit to a network entity transmitting the data identifier a request message to request the data corresponding to the data identifier when the data corresponding to the data identifier are not stored;
a data receiving unit, adapted to receive the data corresponding to the data identifier from the network entity; and,
a data storing unit, adapted to store the data.

12. The data processing apparatus of claim 11, characterized by, further comprising:
a data identifier storing unit, adapted to store the data identifier after the data receiving unit receives the data.

13. The data processing method of claim 11, characterized by, further comprising:
a data identifier transmitting unit, adapted to transmit the data identifier;
a request message receiving unit, adapted to receive a request message requesting the data corresponding to the data identifier; and,
a data transmitting unit, adapted to transmit the data after the request message receiving unit receives the request message.

14. A data processing system, characterized by, comprising: a data distribution source and a transfer server, wherein:
the data distribution source is adapted to configure, after obtaining data, a data identifier for the data, transmit the data identifier, receive a first request message from the transfer server and transmit the data to the transfer server, the first request message being for requesting the data corresponding to the data identifier; and,
the transfer server is adapted to receive the data identifier, transmit the first request message to the data distribution source to request the data corresponding to the data identifier when the data corresponding to the data identifier are not stored, and receive and store the data.

15. The data processing system of claim 14, characterized by, further comprising:
a first client, connected with the transfer server in a client/server manner;
the transfer server being further adapted to transmit the data identifier to the first client after storing the data, receive a second request message from the first client, and transmit the data to the first client, the second request message being for requesting the data corresponding to the data identifier; and,
the first client being adapted to receive the data identifier, transmit the second request message to the transfer server to request the data corresponding to the data identifier when the data corresponding to the data identifier are not stored, receive and store the data.

16. The data processing system of claim 15, characterized by, further comprising:
a second client, connected with the first client in a point-to-point manner;
the first client being further adapted to transmit the data identifier to the second client after storing the data, receive a third request message from the second client, and transmit the data to the second client, the third request message being for requesting the data corresponding to the data identifier; and,
the second client being adapted to receive the data identifier, transmit the third request message to the first client to request the data corresponding to the data identifier if the data corresponding to the data identifier are not stored in the second client, receive and store the data.

17. The data processing system of claim 16, characterized by, further comprising: a third client, when the third client does not receive the data from the first client or the second client;
the third client being adapted to transmit a fourth request message to the transfer server to request the data corresponding to the data identifier, receive and store the data from the transfer server; and,
the transfer server being further adapted to receive the fourth request message and transmit the data requested by the fourth request message to the third client.

18. The data processing system of claim 16, characterized by, further comprising: a fourth client, when the fourth client does not receive the data from the first client, or the second client or the transfer server;
the third client being adapted to transmit a fifth request message to the data distribution source to request the data corresponding to the data identifier, receive and store the data from the data distribution source; and,
the data distribution source being further adapted to receive the fifth request message and transmit the data requested by the fifth request message to the fourth client.

19. The data processing system of claim 14, characterized by, the data distribution source being further adapted to determine whether the size of the data exceeds a pre-defined value after obtaining the data, and further divide the data into data blocks of a pre-defined size and configure a data block identifier for each data block when the size of the data exceeds the pre-defined value; and,
the data identifier transmitted by the data distribution source being the data block identifier.
